(19) United States
(12) Patent Application Publication
(10) Pub. No.: US 2026/0178097 A1
(43) Pub. Date: Jun. 25, 2026

(54) POWER MANAGEMENT INTEGRATED CIRCUIT AND METHOD OF OPERATING POWER MANAGEMENT INTEGRATED CIRCUIT

(71) Applicant: SAMSUNG ELECTRONICS CO., LTD., Suwon-si (KR)

(72) Inventors: Junchul Shin, Suwon-si (KR); Siyoung Ok, Suwon-si (KR); Dahee Kang, Suwon-si (KR); Kyungrae Kim, Suwon-si (KR); Younghun Kim, Suwon-si (KR); Minshik Seok, Suwon-si (KR)

(73) Assignee: SAMSUNG ELECTRONICS CO., LTD., Suwon-si (KR)

(21) Appl. No.: 19/256,641

(22) Filed: Jul. 1, 2025

(30) Foreign Application Priority Data
Dec. 20, 2024 (KR) 10-2024-0192644

(51) Int. Cl. G06F 1/30; G06F 1/28; G06F 11/07; G06F 11/30

(52) U.S. Cl. CPC G06F 1/305; G06F 1/28; G06F 11/0793; G06F 11/3058

(57) ABSTRACT

A power management integrated circuit (PMIC) includes a dynamic voltage scaling (DVS) block configured to generate an output voltage signal, and a DVS monitoring block including a DVS monitoring code generator, and a safety monitoring unit configured to receive a DVS code and detect an error in the DVS code. The DVS block is configured to generate the output voltage signal based on the DVS code obtained by reflecting a DVS trim code in the DVS regulation code, and the DVS trim code is determined by a characteristic of a first digital-to-analog converter (DAC) included in the DVS block. The DVS monitoring code generator is configured to generate the DVS monitoring code obtained by reflecting a DVS monitoring trim code in the DVS regulation code, and the DVS monitoring trim code is determined by a characteristic of a second DAC included in the DVS monitoring block.

### CROSS-REFERENCE TO RELATED APPLICATION(S)

This application claims priority to Korean Patent Application No. 10-2024-0192644 filed on Dec. 20, 2024 in the Korean Intellectual Property Office, the disclosure of which is herein incorporated by reference in its entirety.

### BACKGROUND

An automotive system may need to review components related to functional safety and ensure that, in the event of a failure, the system enters a safe state. This may be crucial because many components related to functional safety are directly connected to the lives and safety of vehicle users. International automotive standard ISO 26262 may define various types of failures and require corresponding safety functions. According to the standard, safety may be classified into automotive safety integrity levels (ASIL), ranging from A to D, where A represents a lowest safety level and D represents a highest safety level.

A power management integrated circuit (PMIC) used in automotive systems may include multiple power rails and various functions, and thus, functional safety is necessarily required in the PMIC. The PMIC may convert a voltage level requested by an application processor (AP) into a digital code. Through dynamic voltage scaling (DVS), the PMIC may maintain a constant slew rate and convert the digital code into a DVS code. The DVS code may be converted into an output voltage, an analog voltage, and may output to the AP.

When an error occurs in a DVS code, a level of an output voltage output to the AP may not be maintained within a normal range. In this case, a vehicle system may perform an abnormal operation. Accordingly, it may be crucial to detect an error in a DVS code on which DVS is performed and to enter a safe state.

### SUMMARY

One or more embodiments of the disclosure provide a power management integrated circuit (PMIC) capable of monitoring whether a dynamic voltage scaling (DVS) code generated by the PMIC is the same as a DVS monitoring code with respect to a request voltage, requested by a host, thereby detecting an error in the DVS code and entering a safe state, and a method of operating the same.

According to an aspect of an example embodiment, there is provided a PMIC including a dynamic voltage scaling (DVS) block configured to generate an output voltage signal based on a DVS regulation code, the DVS regulation code being obtained by converting a voltage level of a request voltage requested by an application processor (AP) into a digital code; and a DVS monitoring block including a DVS monitoring code generator, which is configured to generate a DVS monitoring code based on the DVS regulation code, and a safety monitoring unit, which is configured to receive a DVS code generated using the DVS regulation code and detect an error in the DVS code using the DVS code and the DVS monitoring code, wherein the DVS block is configured to generate the output voltage signal based on the DVS code obtained by reflecting a DVS trim code in the DVS regulation code, and the DVS trim code is determined by a characteristic of a first digital-to-analog converter (DAC), included in the DVS block, configured to convert the DVS code into a first reference voltage signal, and wherein the DVS monitoring code generator is configured to generate the DVS monitoring code obtained by reflecting a DVS monitoring trim code in the DVS regulation code, and the DVS monitoring trim code is determined by a characteristic of a second DAC, included in the DVS monitoring block, configured to convert the DVS monitoring code into a second reference voltage signal.

According to an aspect of an example embodiment, there is provided a PMIC including a dynamic voltage scaling (DVS) block configured to generate an output voltage signal based on a DVS regulation code, the DVS regulation code being obtained by converting a voltage level of a request voltage requested by an application processor (AP) into a digital code; and a DVS monitoring block comprising a DVS monitoring code generator, which is configured to generate a DVS monitoring code based on the DVS regulation code, and a safety monitoring unit, which is configured to receive a DVS code generated by the DVS block using the DVS regulation code and detect an error in the DVS code using the DVS code and the DVS monitoring code, wherein the safety monitoring unit is configured to: obtain, as a DVS trim offset, an absolute value of a difference between the DVS code and the DVS monitoring code, maintained at a constant value, after a first DVS is performed; and obtain a DVS safety code by reflecting the DVS trim offset in the DVS monitoring code, and compare the DVS code with the DVS safety code to determine whether the error is present in the DVS code.

According to an aspect of an example embodiment, there is provided a method of operating a PMIC, the method including obtaining, as a dynamic voltage scaling (DVS) trim offset, an absolute value of a difference between a DVS code and a DVS monitoring code, maintained at a constant value, after a first DVS is performed; generating the DVS code and the DVS monitoring code based on a DVS regulation code, which is obtained by converting a voltage level of a request voltage requested by an application processor (AP) into a digital code; generating a DVS safety code by reflecting the DVS trim offset in the DVS monitoring code; and comparing the DVS code with the DVS safety code to determine whether an error is present in the DVS code.

### BRIEF DESCRIPTION OF DRAWINGS

Example embodiments will be more clearly understood from the following detailed description, taken in conjunction with the accompanying drawings.

FIG. 1 is a schematic block diagram illustrating a vehicle system according to one or more example embodiments.

FIG. 2 is a schematic block diagram illustrating a power management integrated circuit (PMIC) according to one or more example embodiments.

FIG. 3 is a circuit diagram illustrating a PMIC according to one or more example embodiments.

FIG. 4 is a diagram illustrating a safety function signal according to one or more example embodiments.

FIG. 5 is a flowchart illustrating a process of entering, by a vehicle system, a safe state by detecting an error in a dynamic voltage scaling (DVS) code according to one or more example embodiments.

FIG. 6 is a flowchart illustrating a process of monitoring an error in a DVS code of a PMIC according to one or more example embodiments.

FIG. 7 is a diagram illustrating signals generated in a PMIC according to one or more example embodiments.

FIG. 8 is a diagram illustrating signals generated in a PMIC according to one or more example embodiments.

FIG. 9 is a diagram illustrating signals generated in a PMIC according to one or more example embodiments.

FIG. 10 is a flowchart illustrating a process of generating and outputting, by a DVS code generator, a DVS code according to one or more example embodiments.

FIG. 11 is a flowchart illustrating a process of generating and outputting, by a DVS monitoring code generator, a DVS monitoring code according to one or more example embodiments.

### DETAILED DESCRIPTION

Hereinafter, example embodiments will be explained in detail with reference to the accompanying drawings as follows.

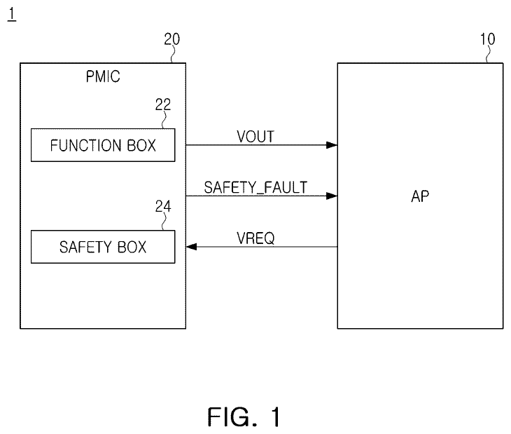

FIG. 1 is a schematic block diagram illustrating a vehicle system according to one or more example embodiments.

Referring to FIG. 1, a vehicle system (or automotive system) 1 may include an application processor (AP) 10 and a power management integrated circuit (PMIC) 20.

The vehicle system 1 may include, for example but not limited to, a power management system, an in-vehicle infotainment system, an autonomous driving system, a vehicle safety system, and an electric vehicle charging system.

The AP 10 may be a central control device that supplies power to the systems included in the vehicle system 1 and control an operation thereof. The AP 10 may request a request voltage VREQ from the PMIC 20 according to an operation state or performance requirement of the systems. For example, when a specific circuit block or function of the vehicle system 1 needs to operate in a low-power mode or a high-performance mode, the AP 10 may request, from the PMIC 20, a request voltage VREQ of a voltage level suitable for a corresponding condition.

The PMIC 20 may be a semiconductor device that performs a power supply function in the vehicle system 1. The PMIC 20 may provide appropriate power to various components of the vehicle system 1, and may include a plurality of power rails and a voltage regulation function for stable power supply.

The AP 10 and the PMIC 20 may closely cooperate with each other through communication, and may operate to maintain power efficiency and functional safety of the vehicle system 1. In particular, to meet the functional safety required by the international automotive safety standard such as ISO 26262, the PMIC 20 may need to accurately control an output voltage VOUT according to the request voltage VREQ requested by the AP 10.

The PMIC 20 may include a function box 12 for performing a dynamic voltage scaling (DVS) function and a safety box 14 for monitoring the function box 12. The function box 12 may include a plurality of dynamic voltage scaling (DVS) blocks for performing a DVS function, and the safety box 14 may include a plurality of DVS monitoring blocks. A single DVS block and a single DVS monitoring block may operate in a pair.

A request voltage VREQ for at least one of a plurality of DVS blocks may have a different voltage level. The DVS block may control the output voltage VOUT according to the request voltage VREQ. In an example embodiment, the DVS block may convert the request voltage VREQ into a DVS code that is a digital code, and may increase or decrease the output voltage VOUT while maintaining a constant slew rate based on the DVS code.

According to one or more example embodiments, a DVS monitoring block may perform a process similar to that of a DVS block paired therewith to convert the request voltage VREQ into a DVS monitoring code. The DVS monitoring block may compare the DVS code and the DVS monitoring code to each other to detect whether an error is present in the DVS code.

According to one or more example embodiments, when an error in the DVS code is detected, the DVS monitoring block may generate and transmit a safety fault signal SAFETY_FAULT, which is a predetermined logic, to the AP 10. The AP 10, that receives the safety fault signal SAFETY_FAULT, which is a predetermined logic, may cause the vehicle system 1 to enter a safe state. For example, the AP 10 may disable a DVS monitoring block, which transmitted the safety fault signal SAFETY_FAULT to the AP 10, and a DVS block paired with that DVS monitoring block. Alternatively, the AP 10 may regulate a voltage level of a request voltage VREQ for the DVS block paired with the DVS monitoring block, which transmitted the safety fault signal SAFETY_FAULT. Accordingly, the vehicle system 1 may ensure safety through interaction between the AP 10 and the PMIC 20.

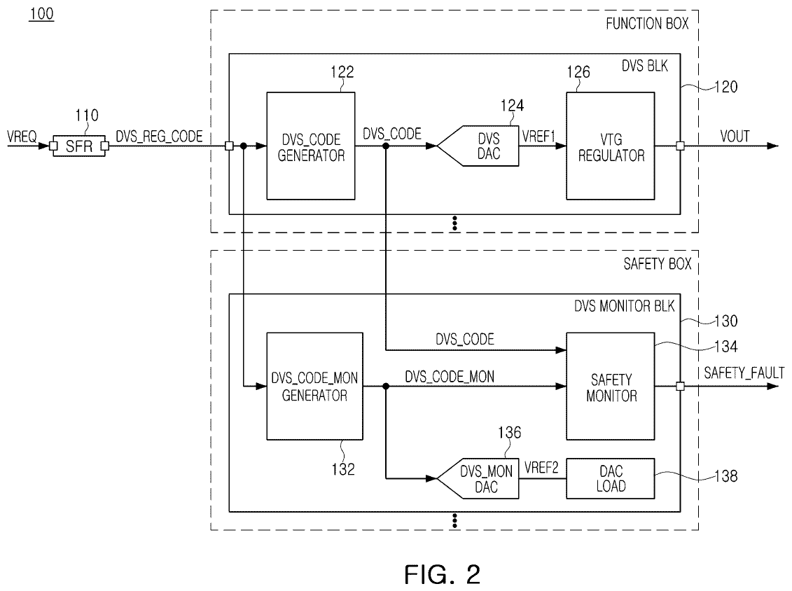

FIG. 2 is a schematic block diagram illustrating a PMIC according to one or more example embodiments.

A vehicle system may include a PMIC 100 and an AP. The PMIC 100 may control an output voltage signal VOUT corresponding to an output voltage level according to a request voltage signal VREQ corresponding to a request voltage level requested by the AP. The PMIC 100 may transmit the output voltage signal VOUT to the AP. Some specific example embodiments of the vehicle system may be similar to those described with reference to FIG. 1.

The PMIC 100 may include a special function register (SFR) 110, a function box, and a safety box. The function box may include a plurality of DVS blocks 120. The safety box may include a plurality of DVS monitoring blocks 130. For example, a number of the plurality of DVS blocks 120 may be the same as a number of the plurality of DVS monitoring blocks 130, and a single DVS block 120 and a single DVS monitoring block 130 may operate in a pair.

The SFR 110 may be a register capable of controlling a function of the PMIC 100 and reading a state of the PMIC 100. The SFR 110 may convert a request voltage level of a request voltage signal VREQ received from the AP into a digital code. The converted digital code may be a DVS regulation code DVS_REG_CODE. The SFR 110 may transmit the DVS regulation code DVS_REG_CODE to the DVS block 120.

The DVS block 120 may include a DVS code generator 122, a DVS digital-to-analog converter (DAC) 124, and a voltage regulator 126.

The DVS code generator 122 may generate the DVS code DVS_CODE using the DVS regulation code DVS_REG_CODE. The DVS DAC 124 may convert the DVS code DVS_CODE into an analog voltage level and output a reference voltage signal VREF1 corresponding to the analog voltage level. The voltage regulator 126 may amplify the reference voltage signal VREF1 and output an output voltage signal VOUT corresponding to the output voltage level. In this case, the output voltage VOUT may be increased or decreased while maintaining a constant slew rate. The voltage regulator 126 may include a buck converter unit or a low dropout regulator LDO.

In one or more example embodiments, when the DVS regulation code DVS_REG_CODE is increased or decreased due to an increase or decrease in the request voltage VREQ, the DVS code generator 122 may increase or decrease the DVS code DVS_CODE by one code every predetermined cycle. An output voltage level of the output voltage signal VOUT may be increased or decreased by a voltage level corresponding to one code every predetermined cycle. For example, the voltage level corresponding to the one code may be 6.25 mV, but the present disclosure is not limited thereto.

The DVS monitoring block 130 may include a DVS monitoring code generator 132, a safety monitoring unit 134, a DVS monitoring DAC 136, and a digital-to-analog conversion load unit 138.

The DVS monitoring code generator 132 may generate a DVS monitoring code DVS_CODE_MON, using the DVS regulation code DVS_REG_CODE received from the DVS block 120. The DVS monitoring code DVS_CODE_MON may be transmitted to the safety monitoring unit 134 and the DVS monitoring DAC 136. The DVS monitoring DAC 136 may convert the DVS monitoring code DVS_CODE_MON into an analog voltage level. A second reference voltage signal VREF2 converted into the analog voltage level by the DVS monitoring DAC 136 may be discharged through the digital-to-analog conversion load unit 138.

According to one or more example embodiments, the safety monitoring unit 134 may receive the DVS code DVS_CODE from the DVS block 120 and receive the DVS monitoring code DVS_CODE_MON from the DVS monitoring code generator 132. The safety monitoring unit 134 may detect whether an error is present in the DVS code DVS_CODE, using the DVS code DVS_CODE and the DVS monitoring code

### DVS_CODE_MON.

For example, when there is no error in the DVS code DVS_CODE, a safety fault signal SAFETY_FAULT having a logic high level (e.g., 1) may be generated and output. The DVS block 120 may continue to generate and output the output voltage signal VOUT, and the DVS monitoring block 130 may continue to monitor whether an error is detected in the DVS code DVS_CODE.

In one or more example embodiments, when there is an error in the DVS code DVS_CODE, a safety fault signal SAFETY_FAULT having a logic low level (e.g., 0) may be generated and output. In this case, the DVS block 120 and the DVS monitoring block 130 may be disabled. Alternatively, a request voltage level for the DVS block 120 may be regulated, thereby ensuring the safety of the PMIC 100.

In one or more example embodiments, the DVS block 120 and the DVS monitoring block 130 may operate in independent power domains, different from each other. The DVS monitoring block 130 may generate the DVS monitoring code DVS_CODE_MON using the DVS regulation code DVS_REG_CODE, which is also used in the DVS block 120. Accordingly, even when an issue arises in the power supply of the DVS block 120, the DVS monitoring block 130 may normally operate to detect an error in the DVS code DVS_CODE.

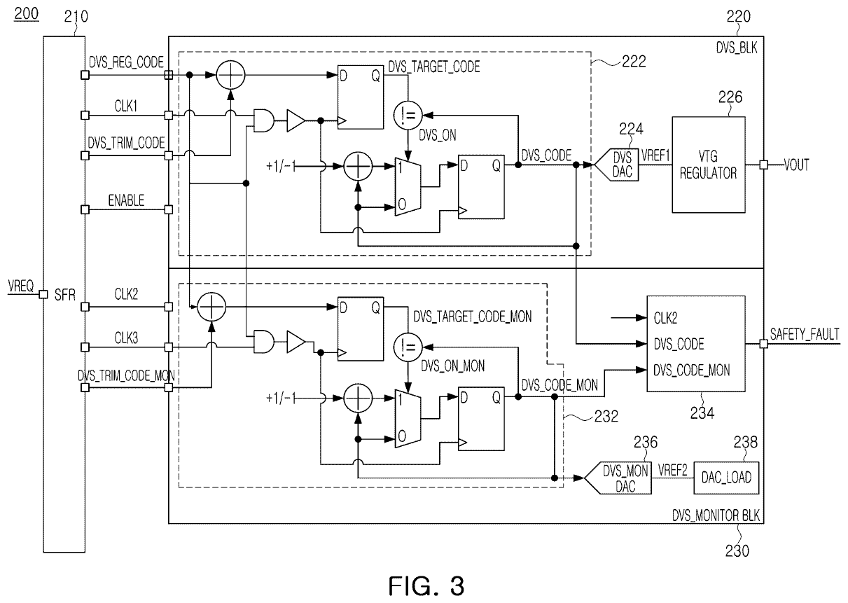

FIG. 3 is a circuit diagram illustrating a PMIC according to one or more example embodiments

A vehicle system may include a PMIC 200 and an AP. The PMIC 200 may control an output voltage signal VOUT corresponding to an output voltage level according to a request voltage signal VREQ requested by the AP. The PMIC 200 may transmit the output voltage signal VOUT to the AP.

The PMIC 200 may include an SFR 210, a plurality of DVS blocks 220, and a DVS monitoring block 230. A single DVS block 220 and a single DVS monitoring block 230 may operate in a pair through a single request voltage signal VREQ. Some specific example embodiments may be similar to those described above with reference to FIGS. 1 and 2. For brevity of description, one DVS block 220 and one DVS monitoring block 230 are illustrated in FIG. 3 as a representative example.

The DVS block 220 may include a DVS code generator 222, a DVS DAC 224, and a voltage regulator 226. The DVS monitoring block 230 may include a DVS monitoring code generator 232, a safety monitoring unit 234, a DVS monitoring DAC 236, and a digital-to-analog conversion load unit 238.

The SFR 210 may transmit an enable signal, a DVS regulation code DVS_REG_CODE, a first clock signal CLK1, and a DVS trim code DVS_TRIM_CODE to the DVS block 220. The SFR 210 may transmit second and third clock signals CLK2 and CLK3 and a DVS monitoring trim code DVS_TRIM_CODE_MON to the DVS monitoring block 230.

The SFR 210 may transmit an enable signal to the DVS block 220. When an operation of the DVS block 220 is not required, the enable signal may be a logic low level. When the operation of the DVS block 220 is required, the enable signal may be changed to a logic high level. In other words, when the output voltage signal VOUT of the DVS block 220 is required, the enable signal may be maintained at the logic high level.

In addition, the SFR 210 may convert a request voltage level of a request voltage signal VREQ received from the AP into a DVS regulation code DVS_REG_CODE and transmit the converted DVS regulation code DVS_REG_CODE to the DVS block 220. The DVS regulation code DVS_REG_CODE may be a digital code. For example, the DVS regulation code DVS_REG_CODE may be an 8-bit code.

The first clock signal CLK1 may have a first frequency. The second clock signal CLK2 may have a second frequency, higher than the first frequency. The third clock signal CLK3 may be a clock signal obtained by dividing the second clock signal CLK2 to have the first frequency. In other words, the first and third clock signals CLK1 and CLK3 may have the same first frequency, and the second clock signal CLK2 may have the second frequency, higher than the first frequency. For example, the second frequency (e.g., 16 MHz) may be twice the first frequency (e.g., 8 MHz). However, the present disclosure is not limited thereto.

The DVS trim code DVS_TRIM_CODE may be a digital code for correcting a characteristic of the DVS DAC 224. The DVS monitoring trim code DVS_TRIM_CODE_MON may be a digital code for correcting a characteristic of the DVS monitoring DAC 236. The DVS trim code DVS_TRIM_CODE and the DVS monitoring trim code DVS_TRIM_CODE_MON may have the same length, and may have a length, less than a length of the DVS regulation code DVS_REG_CODE. For example, the DVS trim code DVS_TRIM_CODE and the DVS monitoring trim code DVS_TRIM_CODE_MON may be 5-bit codes.

The DVS DAC 224 and the DVS monitoring DAC 236 may be provided on different wafers or formed at different positions on a single wafer, and thus may have different distributions. The DVS trim code DVS_TRIM_CODE may correct a distribution of the DVS DAC 224, and the DVS monitoring trim code DVS_TRIM_CODE_MON may correct a distribution of the DVS monitoring DAC 236.

According to one or more example embodiments, the frequencies of the first to third clock signals CLK1 to CLK3, the DVS trim code DVS_TRIM_CODE, and the DVS monitoring trim code DVS_TRIM_CODE_MON may be set in advance before the enable signal is converted into a high level, and may be stored in the SFR 210.

The DVS code generator 222 may generate a DVS target code DVS_TARGET_CODE by summing the DVS regulation code DVS_REG_CODE and the DVS trim code DVS_TARGET_CODE. For example, the DVS target code DVS_TARGET_CODE may be a 9-bit code. The DVS_TARGET_CODE may be provided as an input signal of a D flip-flop. The DVS code generator 222 may input the first clock signal CLK1 and the enable signal to an AND gate. An output signal of the AND gate may be input as a clock signal of the D flip-flop through a buffer gate. The D flip-flop may store the DVS target code DVS_TARGET_CODE according to the clock signal, and may output the stored signal through an output signal thereof.

The DVS code generator 222 may compare the DVS target code DVS_TARGET_CODE and the DVS code DVS_CODE to each other, and may control a logic level of a DVS enable signal DVS_ON according to a result of the comparison. In one or more example embodiments, when the DVS target code DVS_TARGET_CODE and the DVS code DVS_CODE are different from each other, the DVS enable signal DVS_ON may have a logic high level. In other words, when the request voltage level is changed and thus the output voltage level needs to be increased or decreased, the DVS code generator 222 may generate the DVS enable signal DVS_ON having a logic high level. In one or more example embodiments, when the DVS target code DVS_TARGET_CODE is the same as the DVS code DVS_CODE, the DVS enable signal DVS_ON may have a logic low level. In other words, when the request voltage level is not changed and thus the output voltage level needs to be maintained, the DVS code generator 222 may generate the DVS enable signal DVS_ON having a logic low level.

The DVS enable signal DVS_ON may be a selection signal of a multiplexer (MUX). A code, obtained by increasing or decreasing the existing DVS code DVS_CODE by one code, and the existing DVS code DVS_CODE may be provided as inputs of the MUX. For example, the existing DVS code DVS_CODE may be a 9-bit code in the same manner as the DVS target code DVS_TARGET_CODE. The code obtained by increasing or decreasing the existing DVS code DVS_CODE by one code may be a code generated by adding or subtracting 1 to or from a least significant bit (LSB) of the existing DVS code DVS_CODE.

When the DVS enable signal DVS_ON has a logic high level, the MUX may output a code obtained by increasing or decreasing the DVS code DVS_CODE by one code. In other words, when the request voltage level is changed and thus the output voltage level needs to be increased or decreased, the existing DVS code DVS_CODE may be increased or decreased by one code. When the DVS enable signal DVS_ON has a logic low level, the MUX may output the existing DVS code DVS_CODE. In other words, when the request voltage level is not changed and thus the output voltage level needs to be maintained, the same DVS code DVS_CODE may be maintained without being increased or decreased.

The code, output by the MUX, may be provided as an input signal of a D flip-flop. According to the first clock signal CLK1 input to the AND gate and passing through the buffer gate, the D flip-flop may store the DVS code DVS_CODE and output the stored DVS code DVS_CODE through an output signal thereof.

The output DVS code DVS_CODE may be transmitted to the DVS DAC 224 and the safety monitoring unit 234. The DVS DAC 224 may convert the DVS code DVS_CODE into an analog voltage level and output a reference voltage signal VREF1. The voltage regulator 226 may amplify the reference voltage signal VREF1 and output an output voltage signal VOUT corresponding to the output voltage level. In this case, the output voltage VOUT may be increased and decreased while maintaining a constant slew rate.

While the DVS code generator 222 generates the DVS_CODE, the DVS monitoring code generator 232 may generate a DVS monitoring code DVS_CODE_MON. The DVS monitoring code generator 232 may receive the DVS regulation code DVS_REG_CODE from the DVS code generator 222. The DVS monitoring code generator 232 may generate the DVS monitoring code DVS_CODE_MON using the DVS regulation code DVS_REG_CODE similarly to a manner in which the DVS code generator 222 generates the DVS code DVS_CODE.

The DVS monitoring code generator 232 may generate a DVS monitoring target code DVS_TARGET_CODE_MON by summing the DVS regulation code DVS_REG_CODE and the DVS monitoring trim code DVS_TRIM_CODE_MON.

The DVS monitoring target code DVS_TARGET_CODE_MON may be provided as an input signal of a D flip-flop. The DVS monitoring code generator 232 may input the third clock signal CLK3 and the enable signal to an AND gate. In this case, the DVS monitoring code generator 232 may receive the enable signal from the DVS code generator 222. An output signal of the AND gate may be input as a clock signal of the D flip-flop through a buffer gate. The D flip-flop may store the DVS monitoring target code DVS_TARGET_CODE_MON according to the clock signal and output the stored DVS monitoring target code DVS_TARGET_CODE_MON through an output signal thereof.

The DVS monitoring code generator 232 may compare the DVS monitoring target code DVS_TARGET_CODE_MON and the DVS monitoring code DVS_CODE_MON to each other, and may control a logic level of a DVS monitoring enable signal DVS_ON_MON according to a result of the comparison. In one or more example embodiments, when the DVS monitoring target code DVS_TARGET_CODE_MON and the DVS monitoring code DVS_CODE_MON are different from each other, the DVS monitoring enable signal DVS_ON_MON may have a logic high level. In other words, when a request voltage level is changed and thus an output voltage level needs to be increased or decreased, the DVS monitoring code generator 232 may generate the DVS monitoring enable signal DVS_ON_MON having a logic high level. In another example embodiment of the present disclosure, when the DVS monitoring target code DVS_TARGET_CODE_MON and the DVS monitoring code DVS_CODE_MON are the same, the DVS monitoring enable signal DVS_ON_MON may have a logic low level. In other words, when the request voltage level is not changed and thus the output voltage level needs to be maintained, the DVS monitoring code generator 232 may generate the DVS monitoring enable signal DVS_ON_MON having a logic low level.

The DVS monitoring enable signal DVS_ON_MON may be a selection signal of the MUX. A code, obtained by increasing or decreasing the existing DVS monitoring code DVS_CODE_MON by one code, and the existing DVS monitoring code DVS_CODE_MON may be provided as inputs of the MUX.

When the DVS monitoring enable signal DVS_ON_MON has a logic high level, the MUX may output a code obtained by increasing or decreasing the DVS monitoring code DVS_CODE_MON by one code. In other words, when the request voltage level is changed and thus the output voltage level needs to be increased or decreased, the existing DVS monitoring code DVS_CODE_MON may be increased or decreased by one code. When the DVS monitoring enable signal DVS_ON_MON has a logic low level, the MUX may output the existing DVS monitoring code DVS_CODE_MON. In other words, when the request voltage level is not changed and thus the output voltage level needs to be maintained, the DVS monitoring code DVS_CODE_MON may be maintained without being increased or decreased.

The code, output by the MUX, may be provided as an input signal of a D flip-flop. According to the third clock signal CLK3 input to the AND gate and passing through the buffer gate, the D flip-flop may store the DVS monitoring code DVS_CODE_MON and output the stored DVS monitoring code DVS_CODE_MON through an output signal thereof. The output DVS monitoring code DVS_CODE_MON may be transmitted to the safety monitoring unit 234 and the DVS monitoring DAC 236. The DVS monitoring DAC 236 may convert the DVS monitoring code DVS_CODE_MON into a second reference voltage signal VREF2, and the second reference voltage signal VREF2 may be discharged through the digital-to-analog conversion load unit 238.

According to one or more example embodiments, the safety monitoring unit 234 may receive the DVS code DVS_CODE from the DVS code generator 222 and receive the DVS monitoring code DVS_CODE_MON from the DVS monitoring code generator 232. In addition, the safety monitoring unit 234 may receive the second clock signal CLK2 from the SFR 210.

The safety monitoring unit 234 may compare the DVS code DVS_CODE and the DVS monitoring code DVS_CODE_MON to each other to detect whether an error is present in the DVS code DVS_CODE. In this case, the safety monitoring unit 234 may reflect a difference between the DVS trim code DVS_TRIM_CODE and the DVS monitoring trim code DVS_TRIM_CODE_MON and a difference between a power domain of the DVS block 220 and a power domain of the DVS monitoring block 230.

The DVS code DVS_CODE and the DVS monitoring code DVS_CODE_MON may respectively reflect the DVS trim code DVS_TRIM_CODE and the DVS monitoring trim code DVS_TRIM_CODE_MON, which are different from each other. In addition, the power domain of the DVS block 220 may be independent of and different from the power domain of the DVS monitoring block 230. Accordingly, the safety monitoring unit 234 may determine whether the DVS code DVS_CODE and the DVS monitoring code DVS_CODE_MON are the same by reflecting the above differences, that is, the difference between the DVS trim code DVS_TRIM_CODE and the DVS monitoring trim code DVS_TRIM_CODE_MON and the difference between the power domains of the DVS block 220 and the DVS monitoring block 230, in the DVS monitoring code DVS_CODE_MON.

For example, when there is no error in the DVS code DVS_CODE, the safety fault signal SAFETY_FAULT having a logic high level may be generated and output. The DVS block 220 may continue to generate and output the output voltage signal VOUT, and the DVS monitoring block 230 may continue to detect an error in the DVS code DVS_CODE.

In one or more example embodiments, when there is an error in the DVS code DVS_CODE, the safety fault signal SAFETY_FAULT having a logic low level may be generated and output. In this case, the DVS block 220 and the DVS monitoring block 230 may be disabled. Alternatively, a request voltage level for the DVS block 220 may be regulated, thereby ensuring the safety of the PMIC 200.

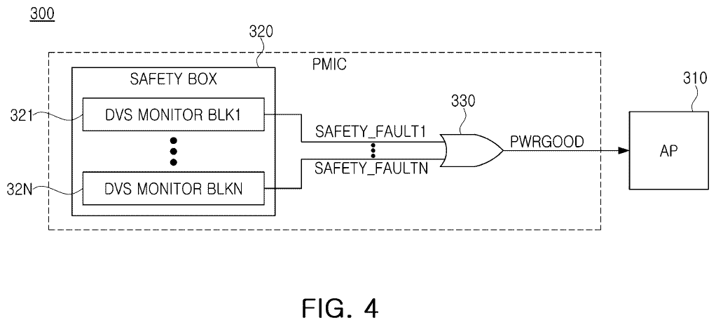

FIG. 4 is a diagram illustrating a safety function signal according to one or more example embodiments.

A vehicle system 300 may include an AP 310 and a PMIC. The PMIC may include a safety box 320 and an OR gate 330. The safety box 320 may include a plurality of DVS monitoring blocks 321 to 32N. Each of the plurality of DVS monitoring blocks 321 to 32N may be paired with a corresponding DVS block to detect an error in a DVS code generated in the corresponding DVS block. Some specific example embodiments of the vehicle system may be similar to those described with reference to FIGS. 1 to 3.

The first to N-th DVS monitoring blocks 321 to 32N may generate first to N-th safety fault signals SAFETY_FAULT1 to SAFETY_FAULTN, respectively. When there is no error in the DVS code, a corresponding DVS monitoring block may generate a safety fault signal SAFETY_FAULT having a logic high level. When there is an error in the DVS code, a corresponding DVS monitoring block may generate a safety fault signal SAFETY_FAULT having a logic low level.

The first to N-th DVS monitoring blocks 321 to 32N may input the first to N-th safety fault signals SAFETY_FAULT1 to SAFETY_FAULTN to the OR gate 330. The OR gate 330 may output a safety function signal PWRGOOD by performing an OR operation on the first to N-th safety fault signals SAFETY_FAULT1 to SAFETY_FAULTN. When at least one of the first to N-th safety fault signals SAFETY_FAULT1 to SAFETY_FAULTN has a logic low level, the OR gate 330 may output a safety function signal PWRGOOD having a logic low level.

When the safety function signal PWRGOOD having a logic low level is transmitted to the AP 310, the PMIC may store information on a DVS block outputting the safety fault signal SAFETY_FAULT having a logic low level. For example, the PMIC may store information on a power rail outputting the safety fault signal SAFETY_FAULT having a logic low level.

When the AP 310 receives the safety function signal PWRGOOD having a logic low level, the AP 310 may request, to the PMIC, the stored DVS block information and/or the power rail information. The AP 310 may disable the DVS block, outputting the safety fault signal SAFETY_FAULT having a logic low level, to enter a safe state.

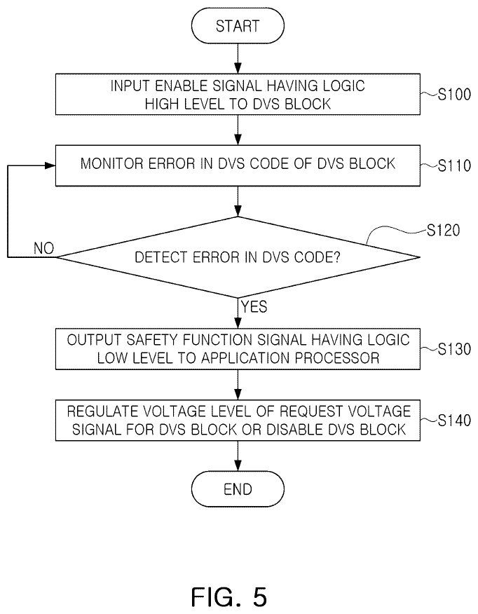

FIG. 5 is a flowchart illustrating a process of entering, by a vehicle system, a safe state by detecting an error in a DVS code according to one or more example embodiments.

A vehicle system may include a PMIC and an AP. The PMIC may include an SFR, a plurality of DVS blocks, and a plurality of DVS monitoring blocks. Each of the plurality of DVS blocks may generate a DVS code and perform DVS on an output voltage signal according to a DVS code. In this case, the plurality of DVS monitoring blocks may respectively monitor errors in DVS codes of DVS blocks paired therewith in real time. In some specific example embodiments of the vehicle system may be similar to those described with reference to FIGS. 1 to 4. Hereinafter, a process of detecting an error in a DVS code will be described in detail.

The SFR may transmit an enable signal having a logic high level to a DVS block (S100). The DVS block may be a single DVS block, that requires an output of an output voltage signal, among the plurality of DVS blocks. A DVS monitoring block may monitor an error in a DVS code of a DVS block paired therewith (S110). For example, the DVS monitoring block may generate a DVS monitoring code through a process similar to that of the DVS block. The DVS monitoring block may detect an error in the DVS code by comparing the DVS code and the DVS monitoring code to each other.

When an error in the DVS code is not detected (“NO” in S120), the DVS monitoring block may repeatedly perform a process of monitoring an error in the DVS code of the DVS block (S110). When an error in the DVS code is detected (“YES” in S120), the PMIC may output a safety function signal having a logic low level to the AP (S130). For example, the DVS monitoring block may output a safety fault signal having a logic low level, and the PMIC may generate a safety function signal having a logic low level by performing an OR operation on the safety fault signal.

The AP may allow the corresponding DVS block and DVS monitoring block to enter a safe state. Referring to FIG. 5, the AP may regulate a voltage level of a request voltage signal for the DVS block or disable the DVS block (S140), thereby ensuring the safety of the vehicle system.

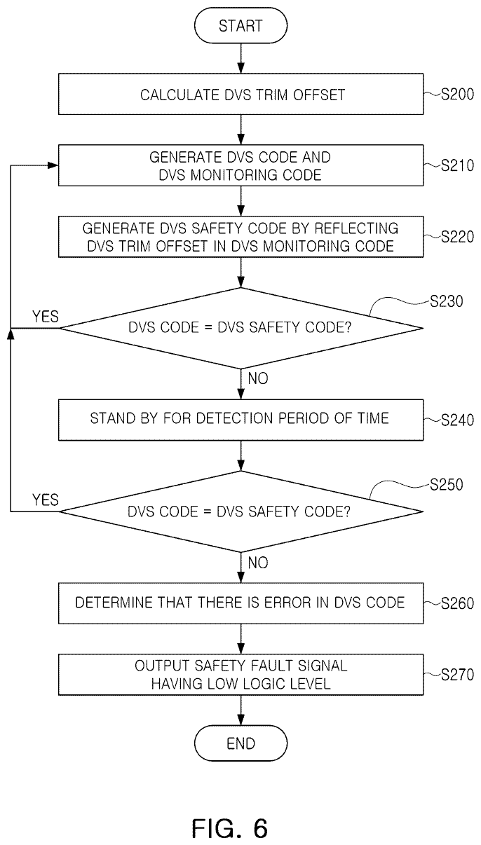

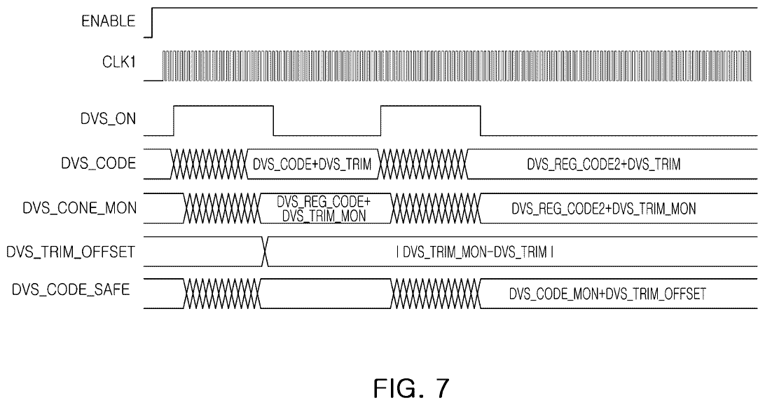

Hereinafter, the process (S110 to S130) of monitoring an error in the DVS code will be described in detail with reference to FIGS. 6 and 7.

FIG. 6 is a flowchart illustrating a process of monitoring an error in a DVS code of a PMIC according to one or more example embodiments. FIG. 7 is a diagram illustrating signals generated in a PMIC according to one or more example embodiments.

A vehicle system may include a PMIC and an AP. The PMIC may include an SFR, a plurality of DVS blocks, and a plurality of DVS monitoring blocks. Each of the plurality of DVS blocks may generate a DVS code and perform DVS on an output voltage signal according to a DVS code. In this case, the plurality of DVS monitoring blocks may respectively monitor an error in DVS codes of the plurality of DVS blocks paired therewith in real time. In some specific example embodiments of the vehicle system may be similar to those described with reference to FIGS. 1 to 5.

Referring to FIG. 6, a DVS block may calculate a DVS trim offset (S200). Referring to FIG. 7 together, while an enable signal is maintained at a low level, a DVS code DVS_CODE, a DVS monitoring code DVS_CODE_MON, a DVS trim offset DVS_TRIM_OFFSET, and a DVS safety code DVS_CODE_SAFE may be set to 0. While the enable signal is maintained at a high level, DVS may be performed according to the DVS code DVS_CODE and the DVS monitoring code DVS_CODE_MON. Specifically, DVS may be performed while a DVS enable signal DVS_ON is maintained at a high level.

In one or more example embodiments, during a first section in which the DVS enable signal DVS_ON is maintained at a high level, the DVS block may calculate and store the DVS trim offset DVS_TRIM_OFFSET. The DVS trim offset DVS_TRIM_OFFSET may be defined as an absolute value of a difference between the DVS code DVS_CODE and the DVS monitoring code DVS_CODE_MON on which DVS has been completed. The DVS block may calculate and store an absolute value of a difference between the received DVS code DVS_CODE and DVS monitoring code DVS_CODE_MON.

A DVS DAC and a DVS monitoring DAC may be formed on different wafers or formed at different positions on a single wafer, and thus have different distributions. The DVS code DVS_CODE and the DVS monitoring code DVS_CODE_MON may be calculated by reflecting the different distributions. In addition, a DVS block and a DVS monitoring block may be operated in different power domains. The DVS trim offset DVS_TRIM_OFFSET may be a digital code obtained by reflecting a difference between different distributions and/or a difference between different power domains in the DVS monitoring code DVS_CODE_MON.

Referring to FIG. 6, a DVS code generator may generate the DVS code DVS_CODE, and the DVS monitoring code generator may generate the DVS monitoring code DVS_MON_CODE (S210). A safety monitoring unit may generate a DVS safety code DVS_CODE_SAFE by reflecting the DVS trim offset DVS_TRIM_OFFSET in the DVS monitoring code DVS_CODE_MON (S220).

In one or more example embodiments illustrated in FIG. 7, the DVS safety code DVS_CODE_SAFE may be a sum of the DVS monitoring code DVS_CODE_MON and the DVS trim offset DVS_TRIM_OFFSET. In one or more example embodiments not illustrated in FIG. 7, the DVS safety code DVS_CODE_SAFE may be a difference between the DVS monitoring code DVS_CODE_MON and the DVS trim offset DVS_TRIM_OFFSET. However, example embodiments are not limited thereto, and the DVS safety code DVS_CODE_SAFE may be any value in which the DVS trim offset DVS_TRIM_OFFSET is reflected in the DVS monitoring code DVS_CODE_MON.

Referring to FIG. 6, the safety monitoring unit may determine whether the DVS code DVS_CODE is the same as the DVS monitoring code DVS_CODE_MON (S230). When the DVS code DVS_CODE is the same as the DVS monitoring code DVS_CODE_MON (“YES” in S230), operations S210 and S220 of generating the DVS monitoring code DVS_MON_CODE and generating the DVS safety code DVS_CODE_SAFE may be repeatedly performed.

When the DVS code DVS_CODE is not the same as the DVS monitoring code DVS_CODE_MON (“NO” in S230), the safety monitoring unit may stand by for a detection period of time (S240). In one or more example embodiments, the detection period of time may be a period of time during which a first clock signal CLK1 repeats several cycles (or predetermined number of cycles). Thereafter, the safety monitoring unit may determine again whether the DVS code DVS_CODE is the same as the DVS monitoring code DVS_CODE_MON (S250).

When the DVS code DVS_CODE and the DVS monitoring code DVS_CODE_MON are the same (“YES” in S250), the operations S210 and S220 of generating the DVS monitoring code DVS_MON_CODE and generating the DVS safety code DVS_CODE_SAFE may be repeatedly performed.

When the DVS code DVS_CODE and the DVS monitoring code DVS_CODE_MON are not the same (NO in S250), the safety monitoring unit may determine that there is an error in the DVS code DVS_CODE (S260). The safety monitoring unit may output a safety fault signal having a low logic level (S270).

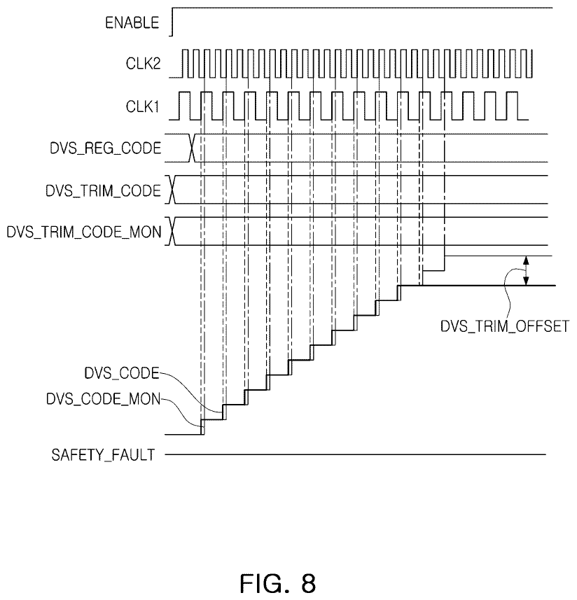

FIG. 8 is a diagram illustrating signals generated in a PMIC according to one or more example embodiments.

Referring to FIGS. 6 to 8, signals of one or more example embodiments illustrated in FIG. 8 may indicate a first section, corresponding to operation S200 of FIG. 6, in which the DVS enable signal DVS_ON of FIG. 7 is maintained at a high level. Hereinafter, a process of calculating a DVS trim offset DVS_TRIM_OFFSET will be described in detail. In some specific example embodiments of a PMIC and an AP may be similar to those described with reference to FIGS. 1 to 7.

While the enable signal (e.g., DVS enable signal DVS_ON) is maintained at a low level, a DVS regulation code DVS_REG_CODE, a DVS code DVS_CODE, and a DVS monitoring code DVS_CODE_MON may be set to 0. A DVS trim code DVS_TRIM_CODE may be determined by a characteristic of a DVS DAC, and a DVS monitoring trim code DVS_TRIM_CODE_MON may be determined by a characteristic of a DVS monitoring DAC. The DVS trim code DVS_TRIM_CODE and the DVS monitoring trim code DVS_TRIM_CODE_MON may respectively have predetermined values, and the predetermined values may be the same or different from each other.

When the DVS regulation code DVS_REG_CODE is changed to a predetermined value, DVS may be performed on an output voltage signal according to the DVS code DVS_CODE. The DVS code DVS_CODE may be increased or decreased by one code every predetermined cycle. Accordingly, the output voltage signal may be increased or decreased while maintaining a constant slew rate.

In one or more example embodiments illustrated in FIG. 8, as a level of a voltage requested by the AP is increased, a value of the DVS regulation code DVS_REG_CODE may be increased. Accordingly, the DVS code DVS_CODE may be increased by one code every predetermined cycle until the DVS code DVS_CODE reaches a sum of the DVS regulation code DVS_REG_CODE and the DVS trim code DVS_TRIM_CODE. For example, the predetermined cycle may be a period of time during which a first clock signal CLK1 repeats one cycle, but the present disclosure is not limited thereto.

In addition, as the level of the voltage requested by the AP is increased, the value of the DVS regulation code DVS_REG_CODE may be increased. Accordingly, the DVS monitoring code DVS_CODE_ MON may also be increased by one code every predetermined cycle. The DVS monitoring code DVS_CODE_MON may be increased by one code until the DVS monitoring code DVS_CODE_MON reaches a sum of the DVS regulation code DVS_REG_CODE and the DVS monitoring trim code DVS_TRIM_CODE_MON. For example, the predetermined cycle may be a period of time during which a second clock signal CLK2 repeats two cycles, but the present disclosure is not limited thereto.

A safety monitoring unit may calculate and store the DVS trim offset DVS_TRIM_OFFSET when constant values of the DVS code DVS_CODE and the DVS monitoring code DVS_CODE_MON are maintained. The DVS trim offset DVS_TRIM_OFFSET may correspond to an absolute value of a difference between the value of the DVS code DVS_CODE and the value of the DVS monitoring code DVS_CODE_MON.

The safety monitoring unit may calculate a DVS safety code DVS_CODE_SAFE by reflecting the DVS trim offset DVS_TRIM_OFFSET in the DVS monitoring code DVS_CODE_MON. The safety monitoring unit may calculate a sum of the DVS monitoring code DVS_CODE_MON and the DVS trim offset DVS_TRIM_OFFSET as the DVS safety code DVS_CODE_SAFE.

The safety monitoring unit may detect an error in the DVS code DVS_CODE by comparing the DVS code DVS_CODE and the DVS safety code DVS_CODE _SAFETY to each other. For example, when the DVS code DVS_CODE and the DVS_CODE_SAFE are different from each other, it may be determined that there is an error in the DVS code DVS_CODE.

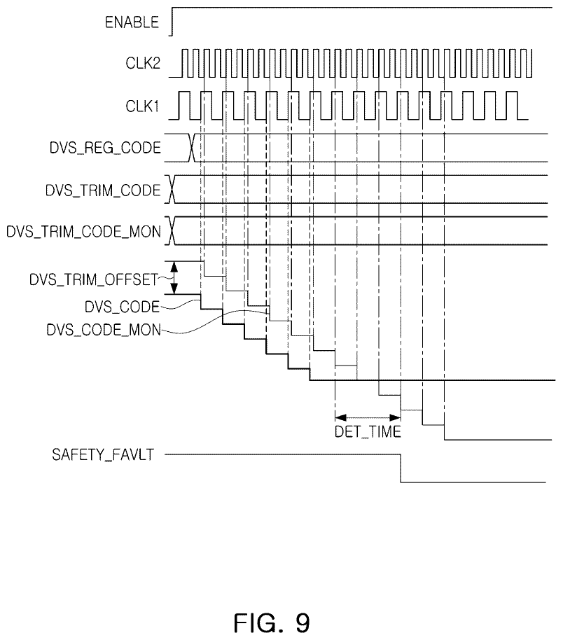

FIG. 9 is a diagram illustrating signals generated in a PMIC according to one or more example embodiments.

Referring to FIGS. 6, 7, and 9, signals of one or more example embodiments illustrated in FIG. 9 may indicate one or more example embodiments of a second section, corresponding to operations S210 to S270 of FIG. 6, in which the DVS enable signal DVS_ON of FIG. 7 is maintained at a high level. Hereinafter, a process of detecting an error in a DVS code DVS_CODE will be described in detail. In some specific example embodiments of a PMIC and an AP may be similar to those described with reference to FIGS. 1 to 8.

Referring to FIG. 9, an enable signal (or DVS enable signal DVS_ON) may be maintained at a high level. A value of a DVS trim code DVS_TRIM_CODE and a value of a DVS monitoring trim code DVS_TRIM_CODE_MON may be maintained while the enable signal is maintained at a high level. For example, the values of each of the DVS trim code DVS_TRIM_CODE and the DVS monitoring trim code DVS_TRIM_CODE_MON may be the same as those illustrated in FIG. 8.

Before a value of a DVS regulation code DVS_REG_CODE is changed to a predetermined value, a value of a DVS code DVS_CODE and a value of a DVS monitoring code DVS_MON_CODE may be maintained. For example, the values of the DVS code DVS_CODE and the DVS monitoring code DVS_MON_CODE may be the same as values of the DVS code DVS_CODE and the DVS monitoring code DVS_MON_CODE after DVS of FIG. 8 is completed. However, the present disclosure is not limited thereto.

In one or more example embodiments illustrated in FIG. 9, as a level of a voltage requested by an AP is decreased, the value of the DVS regulation code DVS_REG_CODE may be decreased. Accordingly, the DVS code DVS_CODE may be decreased by one code for each cycle in which a first clock signal CLK1 repeats one cycle until the DVS code DVS_CODE reaches a sum of the DVS regulation code DVS_REG_CODE and the DVS trim code DVS_TRIM_CODE. In addition, the DVS monitoring code DVS_CODE_MON may be decreased by one code for each cycle in which a second clock signal CLK2 repeats two cycles until the DVS monitoring code DVS_CODE_MON reaches a sum of the DVS regulation code DVS_REG_CODE and the DVS monitoring trim code DVS_TRIM_CODE_MON.

In this case, a safety monitoring unit may calculate a DVS safety code DVS_CODE_SAFE by reflecting a DVS trim offset DVS_TRIM_OFFSET in the DVS monitoring code DVS_CODE_MON. The safety monitoring unit may compare the DVS code DVS_CODE and the DVS safety code DVS_CODE_SAFE to each other to detect an error in the DVS code DVS_CODE.

According to one or more example embodiments of FIG. 9, the DVS code DVS_CODE may maintain a predetermined value even before the DVS code DVS_CODE reaches the sum of the DVS regulation code DVS_REG_CODE and the DVS trim code DVS_TRIM_CODE. In other words, the safety monitoring unit may determine that a value of the DVS code DVS_CODE and a value of the DVS safety code DVS_CODE_SAFE are different from each other. After the safety monitoring unit stands by for a detection period of time DET_TIME, the safety monitoring unit may determine again whether the DVS code DVS_CODE is the same as the DVS safety code DVS_CODE_SAFE.

When the safety monitoring unit determines that the value of the DVS code DVS_CODE and the value of the DVS safety code DVS_CODE_SAFE are different from each other, it may be determined that there is an error in the DVS code DVS_CODE. That is, it may be determined that DVS is abnormally performed as an error occurs in the DVS code DVS_CODE. From the above-described point in time, the safety monitoring unit may change a level of a safety fault signal SAFETY_FAULT from a logic high level to a logic low level and output the safety fault signal SAFETY_FAULT.

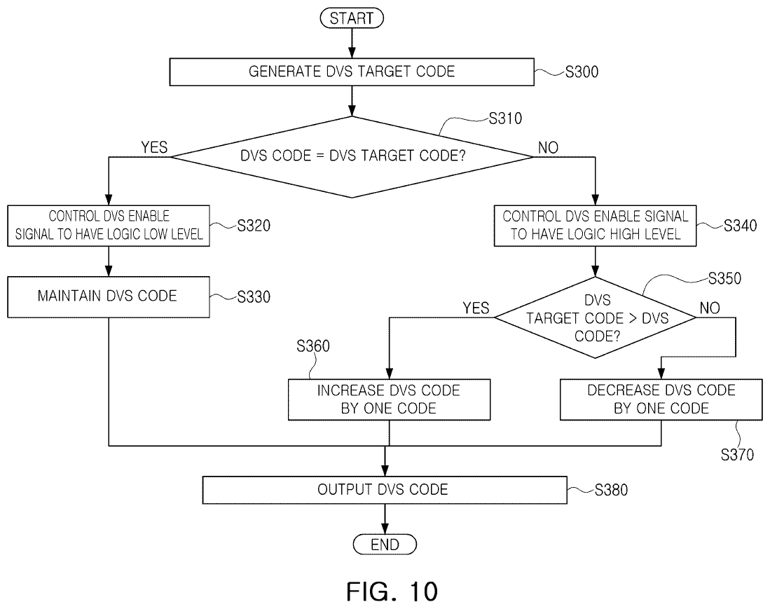

FIG. 10 is a flowchart illustrating a process of generating and outputting, by a DVS code generator, a DVS code according to one or more example embodiments.

When a DVS block receives an enable signal, a DVS code generator may generate and output a DVS code DVS_CODE. In some specific example embodiments of a PMIC and a DVS block included therein may be similar to those described with reference to FIGS. 1 to 9.

The DVS code generator may generate a DVS target code DVS_TARGET_CODE (S300). For example, the DVS code generator may generate the DVS target code DVS_TARGET_CODE by summing a DVS regulation code DVS_REG_CODE and a DVS trim code DVS_TRIM_CODE. The DVS regulation code DVS_REG_CODE may be generated by converting a voltage level of a request voltage requested by an AP into a digital code. The DVS trim code DVS_TRIM_CODE may be determined by a characteristic of a DVS DAC.

The DVS code generator may compare whether an existing DVS code DVS_CODE and the DVS target code DVS_TARGET_CODE are different from each other (S310). When the existing DVS code DVS_CODE and the DVS target code DVS_TARGET_CODE are the same (“YES” in S310), the DVS code generator may control a DVS enable signal DVS_ON to have a logic low level (S320) and thus may maintain the existing DVS code DVS_CODE (S330). In other words, a voltage level of an output voltage signal output by the PMIC may correspond to the voltage level requested by the AP, and therefore, the DVS code DVS_CODE may be maintained.

When the existing DVS code DVS_CODE and the DVS target code DVS_TARGET_CODE are different from each other (“NO” in S310), the DVS code generator may control the DVS enable signal DVS_ON to have a logic high level (S340). Thereafter, the DVS code generator may increase or decrease the DVS code DVS_CODE by one code according to a result of comparison between the DVS target code DVS_TARGET_CODE and the DVS code DVS_CODE (S350 to S370).

When the DVS target code DVS_TARGET_CODE is greater than the DVS code DVS_CODE (“YES” in S350), the DVS code generator may increase the existing DVS_CODE by one code (S360). When the DVS target code DVS_TARGET_CODE is less than the DVS code DVS_CODE (“NO” in S350), the DVS code generator may decrease the existing DVS_CODE by one code (S370).

The DVS code generator may output the DVS code DVS_CODE generated through operations S300 to S370 (S380).

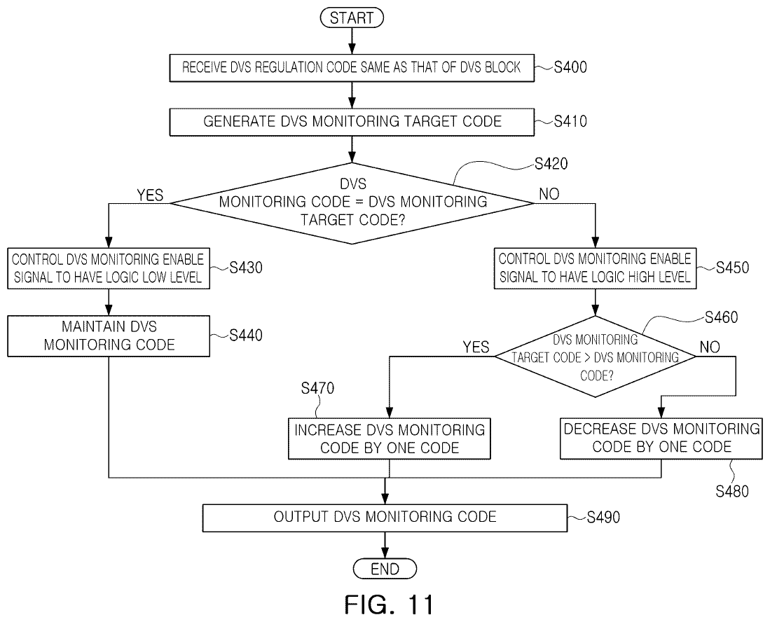

FIG. 11 is a flowchart illustrating a process of generating and outputting, by a DVS monitoring code generator, a DVS monitoring code according to one or more example embodiments.

While a DVS block generates and outputs a DVS code, a DVS monitoring block may generate and output a DVS monitoring code DVS_CODE_MON. The DVS monitoring block may generate the DVS monitoring code DVS_CODE_MON by performing a process similar to that of the DVS block. In some specific example embodiments of a PMIC and a DVS monitoring block included therein may be similar to those described with reference to FIGS. 1 to 10.

A DVS monitoring code generator may receive a DVS regulation code DVS_REG_CODE the same as that of the DVS block (S400). The DVS monitoring code generator may generate a DVS monitoring target code DVS_TARGET_CODE_MON (S410). For example, the DVS monitoring code generator may generate the DVS monitoring target code DVS_TARGET_CODE_MON by summing the DVS regulation code DVS_REG_CODE and a DVS monitoring trim code DVS_TRIM_CODE_MON. The DVS monitoring trim code DVS_TARGET_CODE_MON may be determined by a characteristic of a DVS monitoring DAC.

The DVS monitoring code generator may compare whether an existing DVS monitoring code DVS_CODE_MON and the DVS monitoring target code DVS_TARGET_CODE_MON are the same (S420). When the existing DVS monitoring code DVS_CODE_MON and the DVS monitoring target code DVS_TARGET_CODE_MON are the same (“YES” in S420), the DVS monitoring code generator may control a DVS monitoring enable signal DVS_ON_MON to have a logic low level (S430), and may maintain the existing DVS monitoring code DVS_CODE_MON (S440).

When the existing DVS monitoring code DVS_CODE_MON and the DVS monitoring target code DVS_TARGET_CODE_MON are different from each other (“NO” in S420), the DVS monitoring code generator may control the DVS monitoring enable signal DVS_ON_MON to have a logic high level (S450). Thereafter, the DVS monitoring code generator may increase or decrease the DVS monitoring code DVS_CODE_MON by one code according to a result of comparison between the DVS monitoring target code DVS_TARGET_CODE_MON and the DVS monitoring code DVS_CODE_MON (S460 to S480).

When the DVS monitoring target code DVS_TARGET_CODE_MON is greater than the DVS monitoring code DVS_CODE_MON (“YES” in S460), the DVS monitoring code generator may increase the existing DVS_CODE_MON by one code (S470). When the DVS monitoring target code DVS_TARGET_CODE_MON is less than the DVS monitoring code DVS_CODE_MON (“NO” in S460), the DVS monitoring code generator may decrease the existing DVS monitoring code DVS_CODE_MON by one code (S480).

The DVS monitoring code generator may output the DVS monitoring code DVS_CODE_MON generated through operations S400 to S470 (S490).

According to one or more example embodiments of the present disclosure, a DVS trim code determined by a characteristic of a DAC of a DVS block may be reflected in a DVS code, and a DVS monitoring trim code determined by a characteristic of a DAC of a DVS monitoring block may be reflected in a DVS monitoring code. In addition, a difference may be present between a power domain of the DVS block and a power domain of the DVS monitoring block. A difference between the DVS trim code and the DVS monitoring code and a difference between the power domains may be reflected in the DVS monitoring code generated by the DVS monitoring block to determine whether an error is present in the DVS code. Accordingly, a vehicle system may have improved stability by monitoring the safety of the DVS code.

While example embodiments have been shown and described above, it will be apparent to those skilled in the art that modifications and variations could be made without departing from the scope of the present disclosure as defined by the appended claims.

What is claimed is:

1. A power management integrated circuit (PMIC) comprising:
a dynamic voltage scaling (DVS) block configured to generate an output voltage signal based on a DVS regulation code, the DVS regulation code being obtained by converting a voltage level of a request voltage requested by an application processor (AP) into a digital code; and
a DVS monitoring block comprising a DVS monitoring code generator, which is configured to generate a DVS monitoring code based on the DVS regulation code, and a safety monitoring unit, which is configured to receive a DVS code generated using the DVS regulation code, and detect an error in the DVS code using the DVS code and the DVS monitoring code,
wherein the DVS block is configured to generate the output voltage signal based on the DVS code obtained by reflecting a DVS trim code in the DVS regulation code, and the DVS trim code is determined by a characteristic of a first digital-to-analog converter (DAC), included in the DVS block, configured to convert the DVS code into a first reference voltage signal, and
wherein the DVS monitoring code generator is configured to generate the DVS monitoring code obtained by reflecting a DVS monitoring trim code in the DVS regulation code, and the DVS monitoring trim code is determined by a characteristic of a second DAC, included in the DVS monitoring block, configured to convert the DVS monitoring code into a second reference voltage signal.

2. The PMIC of claim 1, wherein the DVS code is a sum of the DVS regulation code and the DVS trim code.

3. The PMIC of claim 1, wherein the DVS monitoring code is a sum of the DVS regulation code and the DVS monitoring trim code.

4. The PMIC of claim 1, wherein the DVS trim code is different from the DVS monitoring trim code.

5. The PMIC of claim 1, wherein the DVS monitoring block further comprises a digital-to-analog conversion load unit connected to the second DAC, and
wherein the second reference voltage signal is discharged through the digital-to-analog conversion load unit.

6. The PMIC of claim 1, wherein the safety monitoring unit is configured to output a safety fault signal indicating whether the error is present in the DVS code.

7. The PMIC of claim 6, wherein the safety monitoring unit is configured to output the safety fault signal, which has a logic high level, based on detecting the error in the DVS code, and output the safety fault signal, which has a logic low level, based on detecting no error in the DVS code.

8. The PMIC of claim 1, wherein a length of the DVS code is equal to a length of the DVS monitoring code, and a length of the DVS trim code is equal to a length of the DVS monitoring trim code.

9. The PMIC of claim 8, wherein the length of the DVS code is greater than the length of the DVS trim code.

10. A power management integrated circuit (PMIC) comprising:
a dynamic voltage scaling (DVS) block configured to generate an output voltage signal based on a DVS regulation code, the DVS regulation code being obtained by converting a voltage level of a request voltage requested by an application processor (AP) into a digital code; and
a DVS monitoring block comprising a DVS monitoring code generator, which is configured to generate a DVS monitoring code based on the DVS regulation code, and a safety monitoring unit, which is configured to receive a DVS code generated by the DVS block using the DVS regulation code, and detect an error in the DVS code using the DVS code and the DVS monitoring code,
wherein the safety monitoring unit is configured to:
obtain, as a DVS trim offset, an absolute value of a difference between the DVS code and the DVS monitoring code, maintained at a constant value, after a first DVS is performed; and
obtain a DVS safety code by reflecting the DVS trim offset in the DVS monitoring code, and compare the DVS code with the DVS safety code to determine whether the error is present in the DVS code.

11. The PMIC of claim 10, wherein the DVS code and the DVS monitoring code are different from each other.

12. The PMIC of claim 10, wherein, based on the DVS monitoring code being less than the DVS code, the safety monitoring unit is configured to obtain a sum of the DVS monitoring code and the DVS trim offset as the DVS safety code.

13. The PMIC of claim 10, wherein, the DVS monitoring code being greater than the DVS code, the safety monitoring unit is configured to obtain a difference between the DVS monitoring code and the DVS trim offset as the DVS safety code.

14. The PMIC of claim 10, wherein, based on a determination that the DVS code and the DVS safety code are different from each other, the safety monitoring unit is configured to compare again the DVS code with the DVS safety code after an elapse of a detection period of time.

15. The PMIC of claim 14, wherein the safety monitoring unit is configured to detect the error in the DVS code, based on a determination that the DVS code is different from the DVS safety code as a result of comparing again after the elapse of the detection period of time.

16. The PMIC of claim 14, wherein the detection period of time is a period of time during which a clock signal input to the DVS monitoring block repeats a predetermined number of cycles.

17. The PMIC of claim 14, wherein the safety monitoring unit is configured to output a safety fault signal indicating whether the error is present in the DVS code.

18. The PMIC of claim 17, wherein the safety monitoring unit is configured to output the safety fault signal having a logic high level based on detecting the error in the DVS code, and output the safety fault signal having a logic low level based on detecting no error in the DVS code.

19. A method of operating a power management integrated circuit (PMIC), the method comprising:
obtaining, as a dynamic voltage scaling (DVS) trim offset, an absolute value of a difference between a DVS code and a DVS monitoring code, maintained at a constant value, after a first DVS is performed;
generating the DVS code and the DVS monitoring code based on a DVS regulation code, which is obtained by converting a voltage level of a request voltage requested by an application processor (AP) into a digital code;
generating a DVS safety code by reflecting the DVS trim offset in the DVS monitoring code; and
comparing the DVS code with the DVS safety code to determine whether an error is present in the DVS code.

20. The method of claim 19, wherein the determining whether the error is present in the DVS code comprises:
based on a determination that the DVS code is different from the DVS safety code, comparing again the DVS code with the DVS safety code after an elapse of a detection period of time; and
determining that there is the error in the DVS code, based on a determination that the DVS code is different from the DVS safety code as a result of the comparing again after the elapse of the detection period of time.
